(19) United States
(12) Patent Application Publication
(10) Pub. No.: US 2025/0198208 A1
(43) Pub. Date: Jun. 19, 2025

(54) CLAMPING DEVICE FOR WINDOWS AND DOORS

(71) Applicant: Frank F. E. MAYER, Bad Dürkheim (DE)

(72) Inventor: Frank F. E. MAYER, Bad Dürkheim (DE)

(21) Appl. No.: 18/837,201

(22) PCT Filed: Jan. 25, 2023
(86) PCT No.: PCT/EP2023/051756

§ 371 Date: Aug. 9, 2024

(30) Foreign Application Priority Data
Feb. 9, 2022 (DE) 10 2022 102 995.6

(51) Int. Cl. E05C 17/54

(52) U.S. Cl. CPC E05C 17/54

(57) ABSTRACT

The invention relates to a clamping device for windows (22) and/or doors (23), said clamping device comprising: a wedge-like main body (1) having a bottom side (2), a top side (3), a core element (4) and a casing element (5), the heights (1a) of side outer surfaces (6a, 6′a) of the main body (1) increasing from a flat region (1b) in the direction (A) of a high region (1c) in such a way that the main body (1) forms a wedge, and the core element (4) forming a hard sliding track (4a) on the top side (3) and the casing element (5) forming a soft sliding surface (5a) on the top side (3). The aim of the invention is to provide a clamping device which not only combines a stable construction with good clamping properties but which can also be brought into its use position as easily as possible. The invention is characterised in that the soft sliding surface (5a) is chamfered or bevelled in such a way that it slopes laterally outwards in the direction of the side outer surfaces (6a) and/or in that the casing element (5) has a rippled structure (8) on the bottom side (2).

The invention relates to a clamping device for windows and/or doors according to the preamble of claim 1.

Such a clamping device is already known from EP 2 751 361 B1, and is also called a door or window stopper. This clamping device is used to hold or block windows or doors, and prevents a door or window from slamming, swinging open or moving in another undesirable fashion. For this, the clamping device is clamped between a pivotable window and its frame, a windowsill or another abutment. When used on a door, the clamping device is preferably clamped between the door leaf and the floor or another abutment.

In particular when such a clamping device lies on the floor, it is not always easily possible to place the clamping device under a door leaf with good clamping effect.

The invention is therefore based on the object of indicating a clamping device having a stable structure, which not only has good clamping properties but can also be moved into its usage position without problems.

This object is achieved by the features indicated in claim 1.

According to the invention, it was initially found that a clamping device cannot always be placed easily and with very little force between a floor and a door leaf with clamping effect. This is because complex slide and grip force ratios, which influence one another in undesirable fashion, may prevail both between the top side of the clamping device and the door leaf, and also between the underside of the clamping device and the floor. It was furthermore found that a swinging door can even cause an undesired movement of a clamping device such that no clamping effect can be deployed. In this context, it has also been found that it is necessary to be able to place a clamping device securely under a door leaf with little force, e.g. using a foot which is not protected by a shoe. The above-mentioned technical problems are solved by a laterally outward chamfer of a soft sliding surface with adhesive friction. Since the soft sliding surface is chamfered or beveled such that it falls away laterally outwardly, a door leaf swinging laterally onto the base body can easily slide onto and off this again. The sliding of the door leaf is further promoted by a ribbed structure on the underside. The underside faces the floor and suitably lies thereon. Because of the ribbed structure and the ramp-like chamfer, the clamping element can be pushed under a door leaf with little force, but after being pushed in deploys a high clamping force.

In contrast to the clamping device known from EP 2 751 361 B1, a soft sliding surface slopes not only in the rising or falling direction of a largely dimensioned wedge, but also substantially or approximately transversely to these directions, namely at least towards the side outer surfaces.

The soft sliding surface may align flush with the hard sliding track. Since the hard sliding track adheres less strongly to a door than the soft sliding surface, the door can slide easily on the hard sliding track. With simultaneous sliding in the direction of the wedge-like rise of the base body, the door can very easily exert force from above onto the base body and press this against the floor, at least in regions. Alternatively or additionally, the soft sliding surface may form a ramp falling away laterally outwardly at the side outer surfaces. Thus firstly the door can more easily slide over the gripping soft sliding surface, without carrying the base body along because of too great an adhesive friction at the door.

The soft sliding surface may peripherally surround the hard sliding track and form a ramp falling away laterally outwardly on the periphery with slope angles which differ along the periphery. Thus a door can slide relatively easily onto or off the base body from all sides.

This sliding surface may fall away or slope at least at a slope angle selected from the range of 1° to 15°, wherein the slope angle is spanned by the soft sliding surface and a plane containing the entire hard sliding track or at least a portion of the hard sliding track. This angular range has proved particularly advantageous, firstly for generating sufficient clamping effect between the soft sliding surface and a door, and secondly for allowing good sliding of the door onto the base body.

The ribbed structure may have successive ribs. The ribs reduce the effective adhesive friction area between the floor and the base body in a specific contact pressure situation. Alternatively or additionally, the ribs may be wedge-shaped in cross-section. A wedge has only a very small contact line or edge, or possibly bead-like surface, at one end so that the effective adhesive friction area between the floor and the base body can be reduced or enlarged, depending on what force acts on the base body from above and presses this against the floor.

In this context, a rib may have a sloping oblique surface which starts from a base of the underside and ends at a contact edge or contact bead, which may be flat or curved and protrudes from the base. The oblique surface may deploy adhesion with a greater or lesser proportion of its area, depending on the contact pressure force with which the base body is pressed against the floor. Preferably, the oblique surface lies on the floor at its end region facing the branches or high region, namely at the contact edge, only when pressed against the floor.

The oblique surface may slope at an oblique surface angle relative to the base or a support surface for the base body, such as for example a floor, wherein the oblique surface angle is selected from the range of 0.5° to 5°. Such an oblique surface angular range is particularly suitable for use both on tiles and also on carpets.

The oblique surface may have a length which is selected from the range of 2 to 4 mm. Alternatively or additionally, the contact edge or contact bead may protrude from the base with a height in the range of 0.05-0.5 mm. Such a height range is particularly suitable for use both on tiles and also on carpets.

The core element may have laterally outwardly oriented outer surfaces which extend between the underside and the top side, wherein the casing element follows and covers the outer surfaces of the core element. Thus a particularly stable base body can be produced which is peripherally completely encased.

At the flat region, the core element may have a tongue-like free end having at least one tooth or pin which protrudes from its surface and is received and/or encased and/or surrounded by the casing element. Also, multiple teeth or pins or other structures may be provided which create a form fit, force fit and/or substance-bonded connection to the casing element. This guarantees namely that a free tongue of the casing element can no longer easily detach or peel away from the core element, even under severe bending. In particular when the base body is pressed against a window or its frame, in clamping devices of the prior art, the elastomer can detach from the core element. The teeth and/or pins prevent the detachment of the casing element even under very severe bending.

The casing element may protrude 1 to 2 cm beyond the outer edge of the free end of the core element and thereby form a flexibly deformable free end of the casing element. Such a long free end or such a long free tongue made of elastomer can bend with little force application.

The casing element may form three free ends of the base body. This creates a wedge-shaped clamping device, the free ends of which can be pushed into door gaps, window gaps or other constricted spaces. Alternatively or additionally, the core element may form a figure with three free ends which is enclosed in the casing element with its free ends. This stabilizes the casing element against torsion and twisting.

Two substantially laterally outwardly curved branches may be provided which each taper in width to a tip in the direction of the first and second free end and also increase in height, wherein a tongue is provided which increases in height starting from the flat region at the third free end in the direction of the branches, and wherein the two branches and the tongue transform continuously into one another in a central region. This creates a base body which is indeed formed as a large wedge but still forms three free ends, which each separately form a smaller wedge.

The core element may follow the casing element in its taper and height. This stabilizes the casing element against torsion and twisting over its entire extent.

The casing element may be softer than the core element. The casing element thus adheres to doors and windows more strongly than the core element. Alternatively or additionally, the casing element may be made from an elastomer with a Shore A hardness in the range of 50 to 80, and the core element may be made from polypropylene. This makes the core element sufficiently hard but still flexible, and the elastomer, namely a thermoplastic elastomer, sufficiently soft and adhesive.

In the drawings:

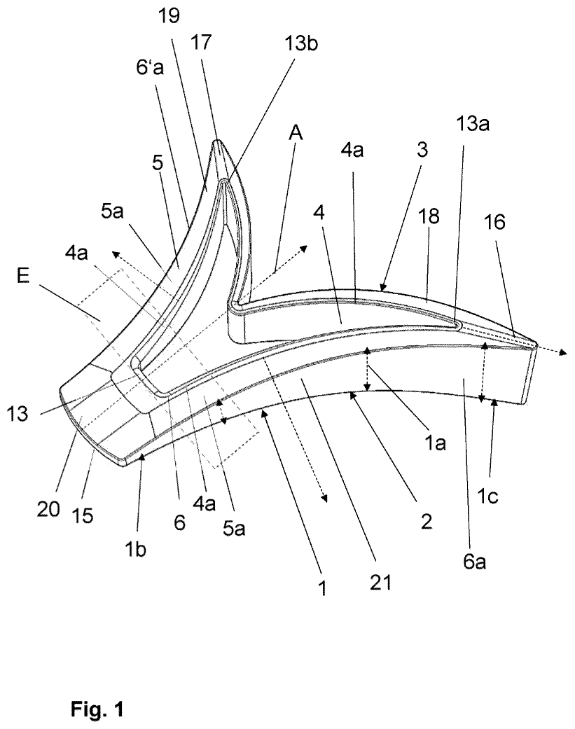

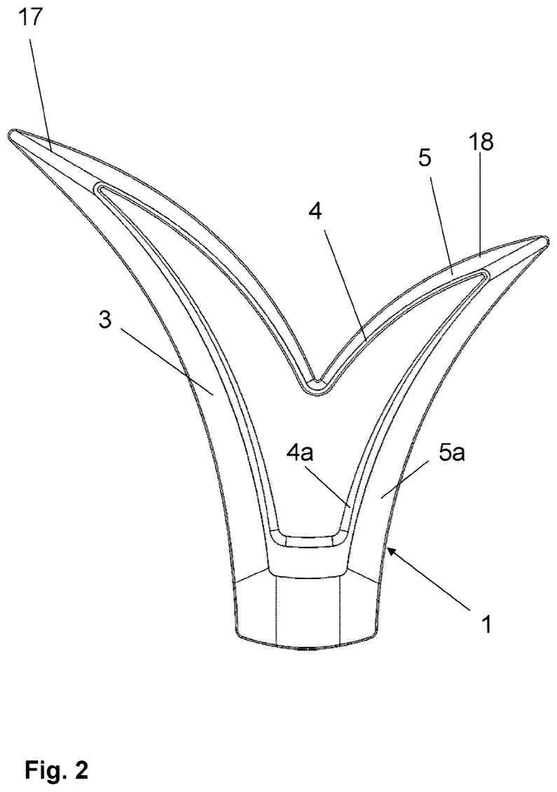

FIG. 1 shows a perspective view of the top side of the clamping device which has no ribbed structure and is smooth,

FIG. 2 shows a plan view onto the top side from FIG. 1,

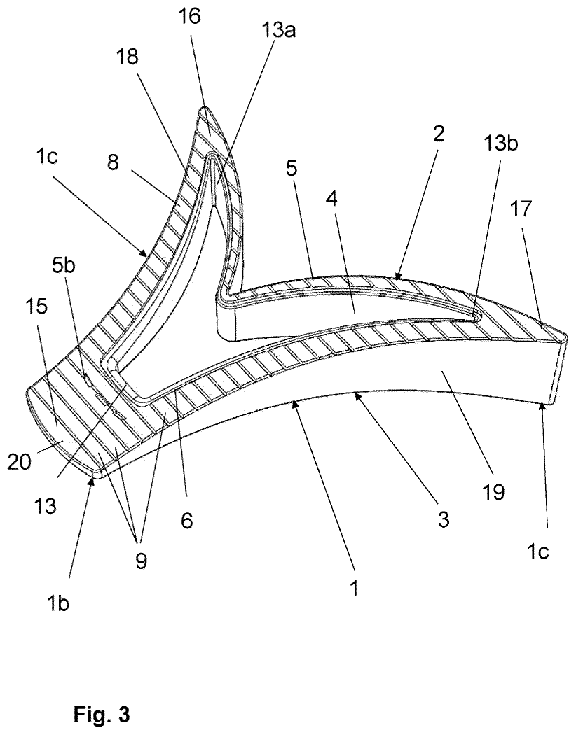

FIG. 3 shows a perspective view of the underside of the clamping device which has a ribbed structure,

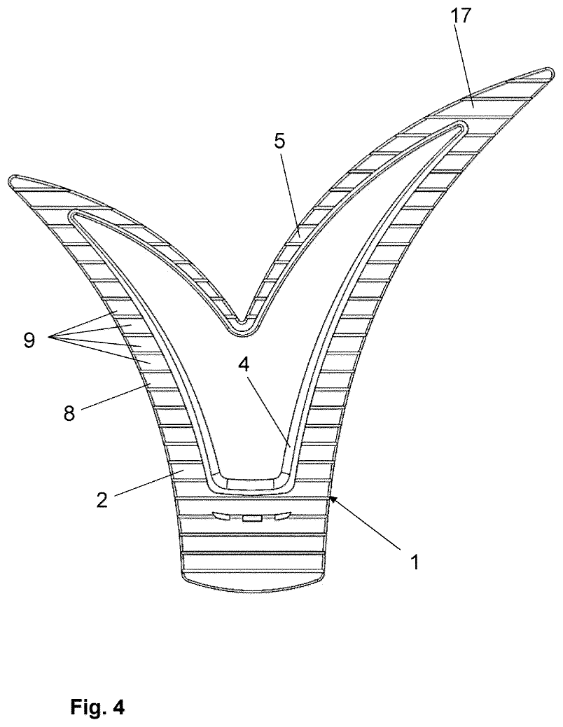

FIG. 4 shows a plan view of the underside from FIG. 3,

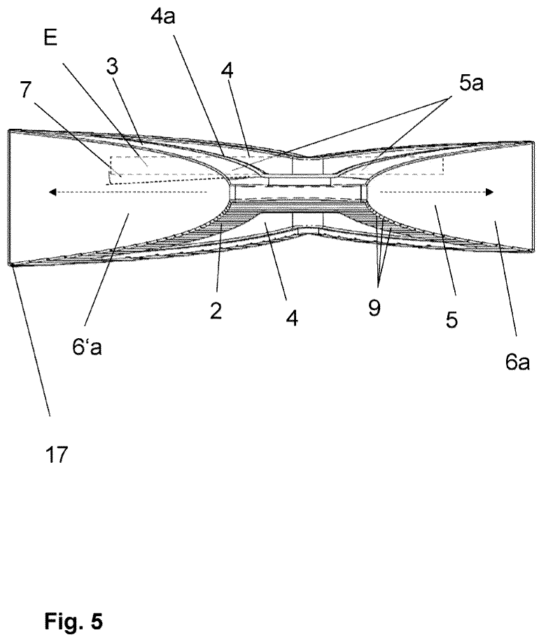

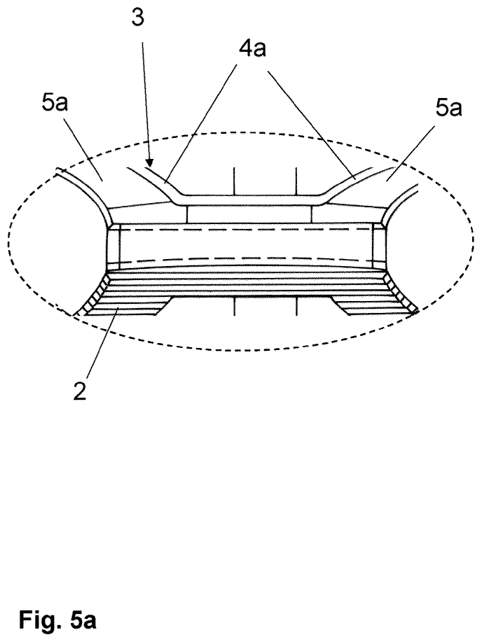

FIG. 5 shows a front view of the clamping device from FIGS. 1 to 4, showing the flat region in the direction of the high region, wherein the underside lies at the bottom in the drawing plane,

FIG. 5a shows a detail view of the chamfered soft sliding surface which falls away laterally outwardly on both sides starting from the hard sliding track,

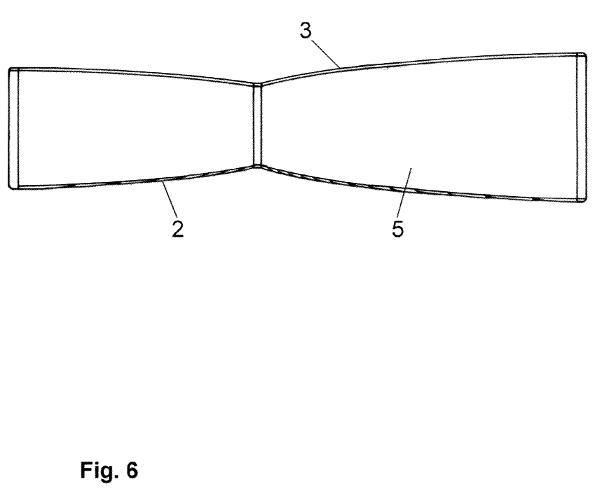

FIG. 6 shows a rear view of the clamping device from FIG. 1, wherein the underside lies at the bottom in the drawing plane,

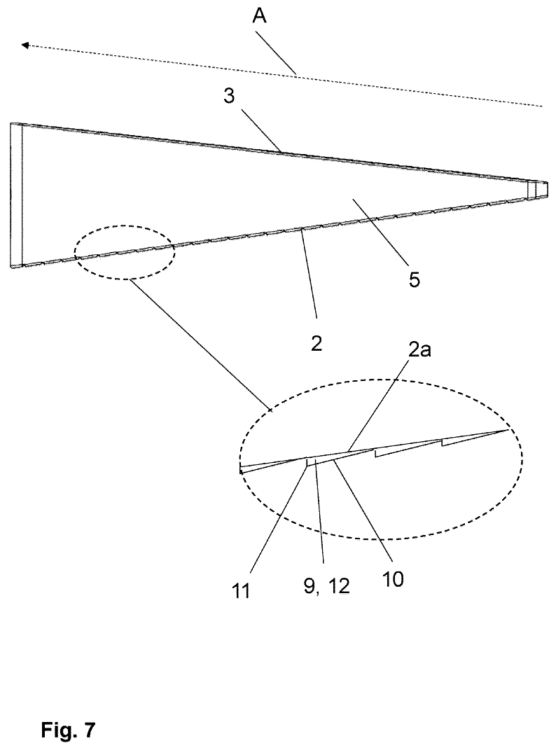

FIG. 7 shows a side view of the clamping device from FIG. 1, wherein the underside lies at the bottom in the drawing plane,

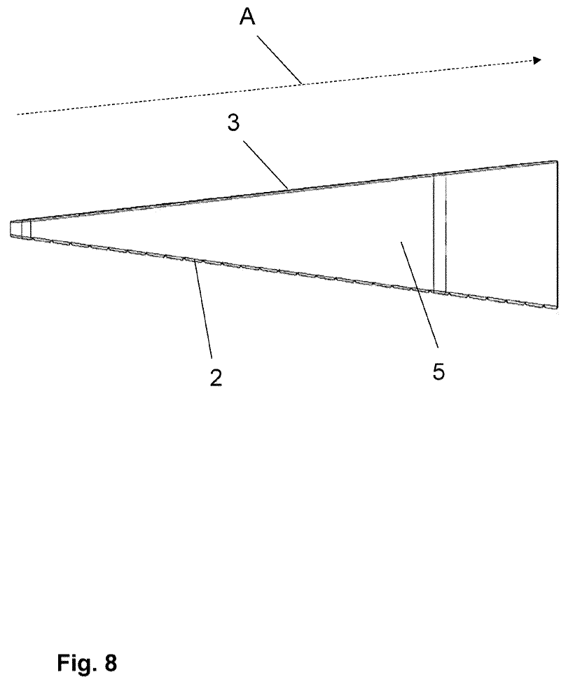

FIG. 8 shows a further side view of the clamping device from FIG. 1, wherein the underside lies at the bottom in the drawing plane,

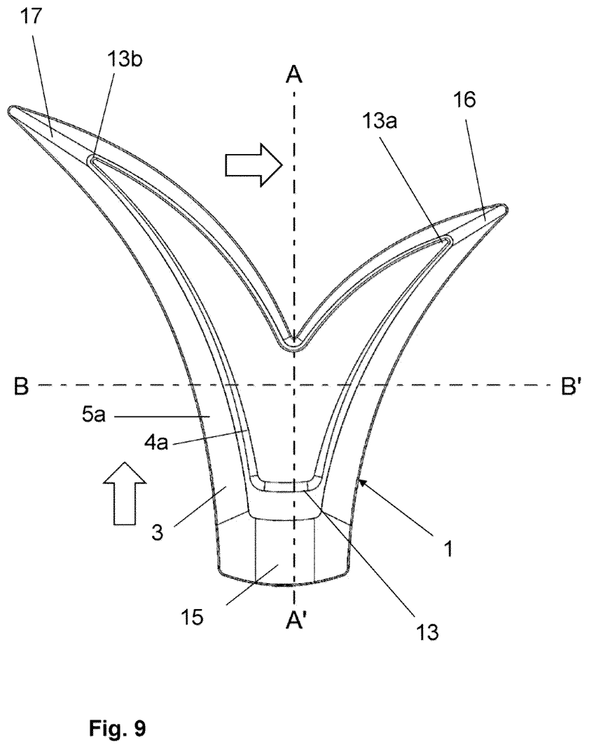

FIG. 9 shows a plan view of the top side of the clamping device from FIG. 1, wherein two section planes and the views onto these are illustrated,

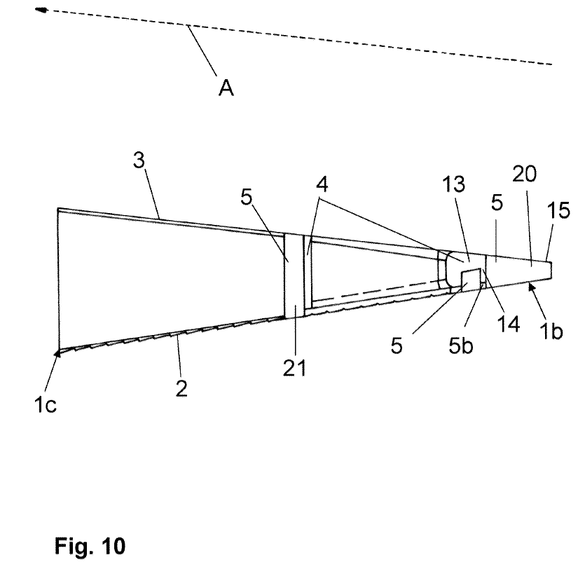

FIG. 10 shows a view onto the section plane A-A′ from FIG. 9, wherein the underside with ribbed structure faces the floor,

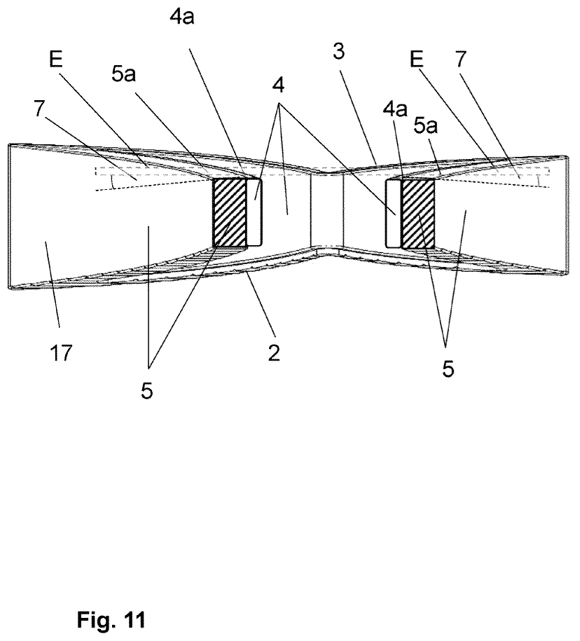

FIG. 11 shows a view onto the section plane B-B′ from FIG. 9, wherein the underside with ribbed structure faces the floor,

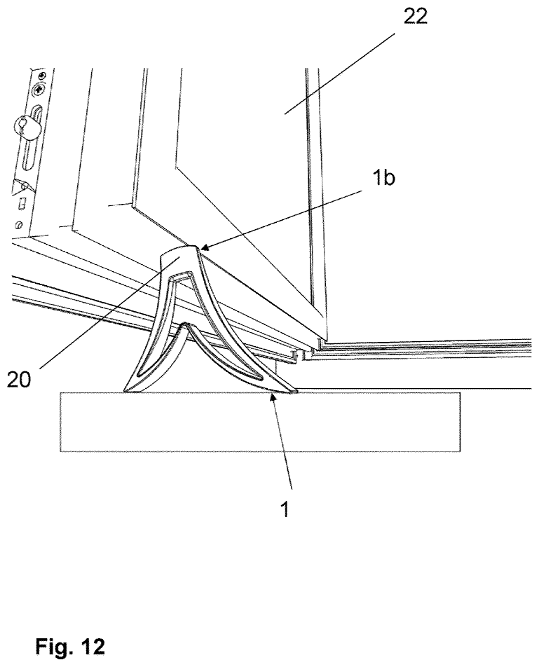

FIG. 12 shows a use of a clamping device as a window stopper, the tongue of which acts from below against a window,

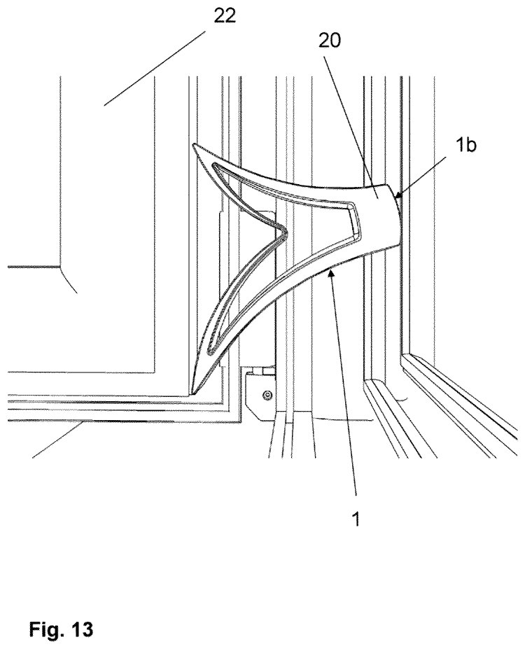

FIG. 13 shows a use of a clamping device as a window stopper, which is clamped between a window and the window frame close to the hinge, and

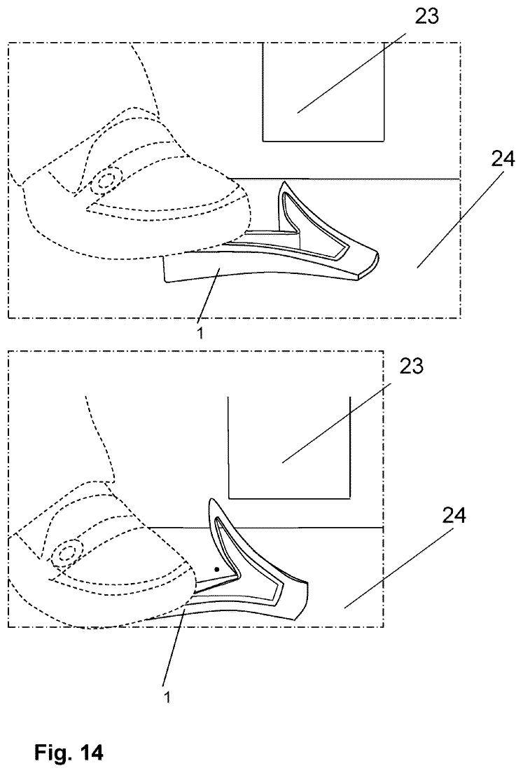

FIG. 14 shows, in the upper view, the insertion of a clamping device between a door and a floor, wherein the underside of the clamping device lies on the floor; and in the lower view, the insertion of a clamping device between a door and a floor, wherein the top side or underside is oriented substantially orthogonally to the floor.

FIG. 1 shows a clamping device for windows and/or doors, comprising a wedge-shaped base body 1 having an underside 2, a top side 3, a core element 4 and a casing element 5, wherein the heights 1a of two side outer surfaces 6a, 6′a of the base body 1 increase starting from a flat region 1b in the direction A of a high region 1c, so that the base body 1 forms a wedge or wedge-like structure.

The core element 4 on the top side 3 forms a peripherally complete and toothed hard sliding track 4a. The casing element 5 forms a soft sliding surface 5a on the top side 3. The soft sliding surface 5a is chamfered or beveled such that it falls away laterally outwardly in the direction of the side outer surfaces 6a, 6a′. This is shown particularly clearly in FIG. 5a.

FIG. 2 shows a plan view of the top side 3, the soft sliding surface 5a and the hard sliding track 4a. The top side 3 is smooth and has no ribs.

FIG. 3 shows that the casing element 5 has a ribbed structure 8 on the underside 2 of the base body 1.

FIG. 4 shows a plan view onto the underside 2, showing that the ribbed structure 8 has successive ribs 9 which are oriented substantially parallel to one another. The ribs 9 extend over the entire underside 2. The top side 3 however is totally smooth and has no ribs.

FIG. 5 shows that the soft sliding surface 5a aligns flush with the hard sliding track 4a, and forms a ramp falling away laterally outwardly at the side outer surfaces 6a. FIGS. 1 and 2 show that the soft sliding surface 5a peripherally surrounds the hard sliding track 1a and forms a ramp falling away laterally outwardly on the periphery with slope angles 7 which differ along the periphery.

FIGS. 5 and 11 show, in a sectional illustration of a slope angle 7, that the soft sliding surface 5a falls away or slopes at a slope angle 7 which is selected from the range of 1° to 15°, wherein the slope angle 7 is spanned by the soft sliding surface 5a and a plane E which contains the hard sliding track 4a. FIG. 5a shows in detail the outward slope of the soft sliding surface 5a on two sides of the base body 1.

FIGS. 5 and 11 show clearly that a portion of the hard sliding track 4a, from which the soft sliding surface 5a falls away laterally outwardly on two sides, lies in the plane E. FIGS. 5 and 11 show that the soft sliding surface 5a falls away laterally outwardly on two sides. This is illustrated in FIG. 5 by two dotted arrows.

FIG. 7 shows, in a side view and an enlarged detail view, that the ribbed structure 8 of the underside 2 has ribs 9 with wedge-shaped cross-section. The detail view is illustrated in a dotted ellipse. Multiple ribs 7 are arranged one behind the other in the manner of a saw blade in cross-section.

FIG. 7 shows in detail that a rib 9 has a sloping oblique surface 10 which starts from a base 2a of the underside 2 and ends at a contact edge 11 protruding from the base 2a.

When the clamping device is in the usage position, the contact edge 11 lies on the floor. The oblique surface 10 slopes at an oblique surface angle 12 relative to the base 2a, wherein the oblique surface angle 12 is selected from the range of 0.5° to 5°. The oblique surface 10 has a length selected from the range of 2 to 4 mm. The contact edge 11 protrudes from the base 2a with a height in the range of 0.05-0.5 mm.

FIG. 1 shows that the core element 4 has laterally outwardly oriented outer surfaces 6 which extend between the underside 2 and the top side 3, wherein the casing element 5 follows the outer surfaces 6 of the core element 4 and completely covers these laterally outwardly. The core element 4 has a cavity in its interior, the inner wall of which is not covered by the casing element 5.

FIG. 3 in conjunction with FIG. 10 shows that at the flat region 1b, the core element 4 has a tongue-like free end 13 having at least one tooth 14 which protrudes from its surface and is received and encased by the casing element 5. In concrete terms, three large teeth and four smaller teeth 14 are provided, which are arranged in rows one behind the other. The casing element 5 forms three viewing windows 5b through which the three larger teeth 14 are visible in plan view onto the underside 2.

FIG. 10 also shows that the casing element 5 protrudes by one to two centimeters beyond the outer edge of the free end 13 of the core element 4, and thereby forms a flexibly deformable free end 15 of the casing element 5.

FIG. 1 shows that the casing element 5 forms three free ends 15, 16, 17 of the base body 1, and that the core element 4 forms a figure with three free ends 13, 13a, 13b which are encased by the free ends 15, 16, 17 of the casing element 5. The core element 4 is hollow, wherein the cavity is also a figure encased by the core element 4.

The base body 1 has two substantially outwardly curved branches 18, 19 of different lengths, which each taper in width to a tip in the direction of a first and second free end 16, 17, and also increase in height. The two branches 18, 19 are arranged in a V-shape and their tips turn away from one another and curve outward.

The base body 1 has a tongue 20 which increases in height in the manner of a wedge, starting from the flat region 1b at the third free and 15 in the direction of the branches 18, 19, wherein the two branches 18, 19 and the tongue 20 transform into one another continuously in a central region 21.

The branches 18, 19 have neither the same length nor the same height at their tips. The side outer surfaces 6a, 6′a are also not of equal height and rise to different extents starting from the flat region 1b to the high region 1c. The core element 4 follows the casing element 5 in its taper and elevation course, and replicates this in its body.

The casing element 5 is softer than the core element 4. The casing element 5 is made from a thermoplastic elastomer with Shore A hardness in the range from 50 to 80, and the core element 4 is made from polypropylene.

FIGS. 12 and 13 show the use of the clamping device 1 on a window 22.

In FIG. 12, the tongue 20 is pressed from below against the window 22, while the branches rest on a windowsill. The tongue 20 can easily be bent very greatly without the elastomer detaching from the core element 4.

In FIG. 13, the tongue 20 is pressed against the window frame in a hinge region while the branches rest on the window 22. The tongue 20 can easily be bent very greatly without the elastomer detaching from the core element 4.

FIG. 14 shows the use of a clamping device 1 on a door 23 in different orientations, when pushed between the door 23 and a floor 24 by a foot.

The clamping device described herein can easily be pushed under a door 23 by a foot, even without shoe, without injury. The door 23 can easily slide onto and off the clamping device.

### LIST OF REFERENCE SIGNS

1 Base body
1a Height of 6a, 6′a
1b Flat region of 1
1c High region of 1
2 Underside of 1
2a Base of 2
3 Top side of 1
4 Core element of 1
4a Hard sliding track of 4 on 3
5 Casing element of 1
5a Soft sliding surface of 5 on 3
5b Viewing window in 5
6 Outer surfaces of 4 facing laterally outward
6a Side outer surface of the shorter branch facing laterally outward
6′a Side outer surface of the longer branch facing laterally outward
7 Slope angle of 5a
8 Ribbed structure
9 Rib of 2
10 Oblique surface of 9
11 Contact edge of 9
12 Oblique surface angle
13 Third free end of 4
13a First free end of 4 on shorter branch
13b Second free end of 4 on longer branch
14 Tooth of 4
15 Third free end of 5
16 Free end of 5 on short branch
17 Free end of 5 on long branch
18 Short branch
19 Long branch
20 Tongue
21 Central region of 1, 4, 5
22 Window
23 Door
24 Floor
A Direction of wedge-shaped rise
E Plane of 4a

1. A clamping device for windows and/or doors, comprising a wedge-like base body having an underside, a top side, a core element and a casing element, wherein the heights of side outer surfaces of the base body increase starting from a flat region in the direction (A) of a high region such that the base body forms a wedge, and wherein the core element forms a hard sliding track on the top side and the casing element forms a soft sliding surface on the top side,
herein the soft sliding surface is chamfered or beveled such that it falls away laterally outwardly in the direction of the side outer surfaces and/or that the casing element has a ribbed structure on the underside.

2. The clamping device as claimed in claim 1, wherein the soft sliding surface aligns flush with the hard sliding track and/or forms a ramp falling laterally away outwardly at the side outer surfaces.

3. The clamping device as claimed in claim 1, wherein the soft sliding surface peripherally surrounds the hard sliding track and forms a ramp falling away laterally outwardly on the periphery with slope angles which differ along the periphery.

4. The clamping device as claimed in claim 1, wherein the soft sliding surface falls away or slopes at least at one slope angle selected from the range of 1° to 15°, wherein the slope angle is spanned by the soft sliding surface and a plane (E) containing the hard sliding track.

5. The clamping device as claimed in claim 1, wherein the ribbed structure has successive ribs and/or ribs which are wedge-shaped in cross-section.

6. The clamping device as claimed in claim 5, wherein a rib has a sloping oblique surface which starts from a base of the underside and ends at a contact edge or contact bead which protrudes from the base.

7. The clamping device as claimed in claim 6, wherein the oblique surface slopes at an oblique surface angle relative to the base or a support surface for the base body, wherein the oblique surface angle is selected from the range of 0.5° to 5°.

8. The clamping device as claimed in claim 6, wherein the oblique surface has a length which is selected from the range of 2 to 4 mm and/or that the contact edge or contact bead protrudes from the base with a height in the range of 0.05-0.5 mm.

9. The clamping device as claimed in claim 1, wherein the core element has laterally outwardly oriented outer surfaces which extend between the underside and the top side, wherein the casing element follows and covers the outer surfaces of the core element.

10. The clamping device as claimed in claim 1, wherein at the flat region, the core element has a tongue-like free end having at least one tooth or pin which protrudes from its surface and is received and/or encased and/or surrounded by the casing element.

11. The clamping device as claimed in claim 10, wherein the casing element protrudes 1 to 2 cm beyond the outer edge of the free end of the core element and thereby forms a flexibly deformable free end of the casing element.

12. The clamping device as claimed in claim 1, wherein the casing element forms three free ends of the base body, and/or that the core element forms a figure with three free ends which is enclosed in the casing element with its free ends.

13. The clamping device as claimed in claim 12, wherein two laterally outwardly curved branches are provided which each taper in width to a tip in the direction of the first and second free end and also increase in height, wherein a tongue is provided which increases in height starting from the flat region at the third free end in the direction of the branches, and wherein the two branches and the tongue transform continuously into one another in a central region.

14. The clamping device as claimed in claim 1, wherein the core element follows the casing element in its taper and elevation.

15. The clamping device as claimed in claim 1, wherein the casing element is softer than the core element and/or that the casing element is made from an elastomer with a Shore A hardness in the range of 50 to 80 and the core element is made from polypropylene.
